(19) United States
(12) Patent Application Publication
(10) Pub. No.: US 2002/0038430 A1
(43) Pub. Date: Mar. 28, 2002

(54) System and method of data collection, processing, analysis, and annotation for monitoring cyber-threats and the notification thereof to subscribers

(76) Inventors: Charles Edwards, Potomac, MD (US); Samuel Migues, Chantilly, VA (US); Roger J. Nebel, Arlington, VA (US); Daniel Owen, Jonasboro, AR (US)

Correspondence Address: Edward J. Kondracki, MILES & STOCKBRIDGE P.C., Suite 500, 1751 Pinnacle Drive, McLean, VA, 22102-3833, US

(21) Appl. No.: 09/950,820

(22) Filed: Sep. 13, 2001

Related U.S. Application Data
(60) Provisional application No. 60/230,932, filed on Sep. 13, 2000.

(51) Int. Cl. G06F 11/30

(52) U.S. Cl. 713/200

(57) ABSTRACT

A system and method for the collection, analysis, and distribution of cyber-threat alerts. The system collects cyber-threat intelligence data from a plurality of sources, and then preprocesses the intelligence data for further review by an intelligence analyst. The analyst reviews the intelligence data and determines whether it is appropriate for delivery to subscribing clients of the cyber-threat alert service. The system reformats and compiles the intelligence data and automatically delivers the intelligence data through a plurality of delivery methods.

### CROSS REFERENCE TO RELATED APPLICATION

The subject matter of this invention is related to Provisional Application Ser. No. 60/230,932, filed Sep. 13, 2000. The subject matter of said application is hereby incorporated by reference.

### FIELD OF THE INVENTION

This invention relates to a system and method for monitoring cyber-threats on a computer network infrastructure, and more particularly to a system and method for the collection, analysis, and distribution of cyber-threat alerts.

### DESCRIPTION OF RELATED ART

Due to the advancement of computer technology and decreasing costs, computer networks have become common among organizations and businesses. Many organizations rely on its computer network infrastructure for day to day activities, as well as entrust it with vital and critical information. With these networks becoming evermore complex, it becomes more difficult to defend them from unwanted intrusion. Organizations with a critical network infrastructure desire awareness of technology threats, vulnerabilities, and other electronic infrastructure issues. Attentiveness to these issues allows an organization to take a proactive approach to defending and protecting its critical infrastructure.

There are a plurality of sources that disclose recent and common threats, vulnerabilities, and other electronic infrastructure issues. Current sources include, but are not limited to, Internet sites (news and underground related sites), email distribution lists and listserves, usenets and chat room dialogue, newsfeeds and wireservices, classified federal government sources, cyber-threat information databases, etc. Some organizations use a team of experts to manually reference these sources to protect the organization's infrastructure. However, variations in content among sources can be troublesome, particularly due to the time-consuming process required to check a large enough sample of sources to determine which variation of the content is reported most frequently and therefore deemed most accurate. Due to the volume of data, only minimal interaction between experts comparing and contrasting data and content can occur in a timely fashion. This analysis process also periodically causes redundancies and omissions.

Accordingly, in light of the above, there is a strong need in the art for an improved system and method for the collection, storage, analysis, production, and delivery of intelligence data for monitoring cyber-threats.

### BRIEF DESCRIPTION OF THE INVENTION

In the present embodiment, the invention proposes a system and method for automating the collection, storing, analysis, production, and delivery of intelligence data for monitoring cyber-threats. In particular, the invention captures the content of intelligence data from a plurality of sources including, but not limited to, Internet sites (news and underground related sites), email distribution lists and listserves, usenets and chat room dialogue, newsfeeds and wireservices, classified federal government sources, cyber-threat information databases, etc. The intelligence data is stored in a first data store, and further sent to one or several queues based on the content of the data. Data analysts then review the items specific to their queue and retain or discard the content.

If analysts choose to retain the intelligence data, a record is created in a second data store and will be referred to as a Knowledge Object (KO) for the remainder of this patent. The KO is then replicated to a “published” database where the data is made available to subscribing customers. Subscribing customers have profiles on record which permit the “push” of data relevant to their profile. Subscribers also have the ability to “pull” information from the database. Delivery of the information to subscribers can exist in a plurality of formats, including but not limited to, using Hyper-Text Transfer Protocol (HTTP), e-mail, facsimile, hard copy, phone message, etc.

### BRIEF DESCRIPTION OF THE DRAWINGS

FIG. 1. illustrates the method processes of the preferred embodiment of the present invention.

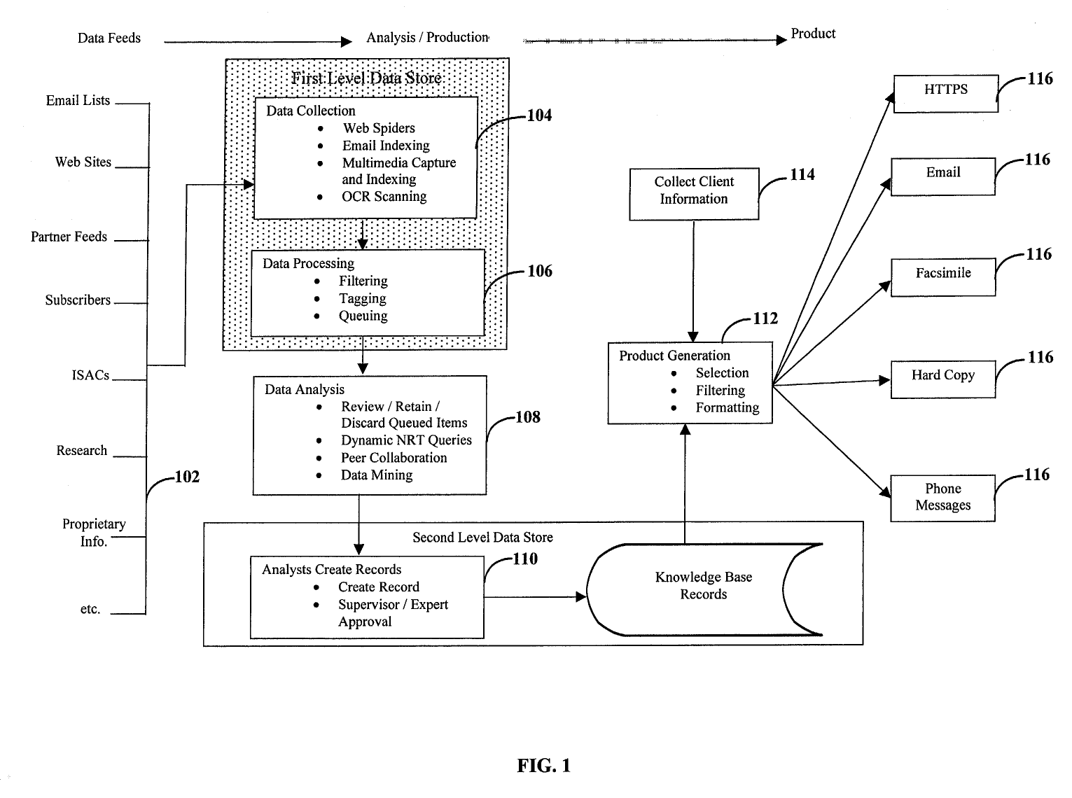

FIG. 2. illustrates the system architecture of the preferred embodiment of the present invention.

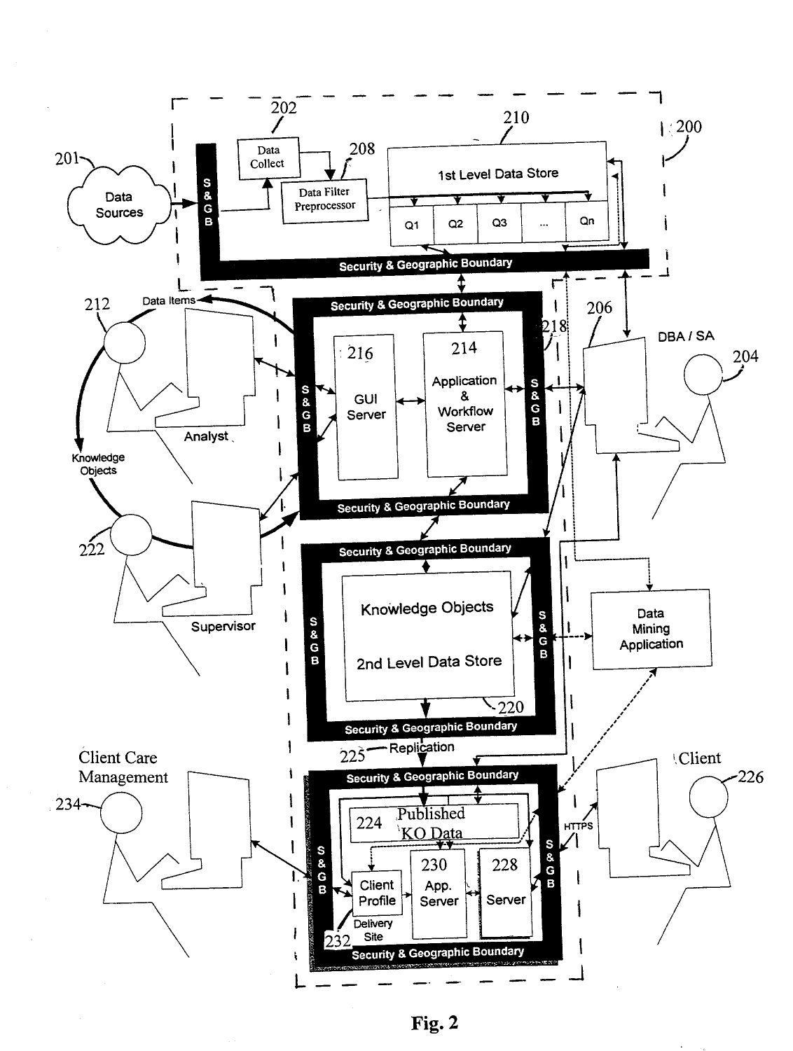

FIG. 3. illustrates a detailed flow chart of the data preprocessing step of the present method.

### DETAILED DESCRIPTION OF THE INVENTION

Reference will now be made in detail to the preferred embodiments of the present invention, examples of which are illustrated in the accompanying drawings.

The present method automates the capture and collection of intelligence data feed elements from a plurality of data sources 102. In one embodiment, data feed elements include, but are not limited to, World Wide Web Internet sites (hacker, vendor, news and underground related sites), email distributions lists and listserves, usenets, chat room dialogue, BBS, video, audio, newsfeeds/wireservices, hardcopy, state and local government feeds, etc. The intelligence data is collected at the data collection step 104.

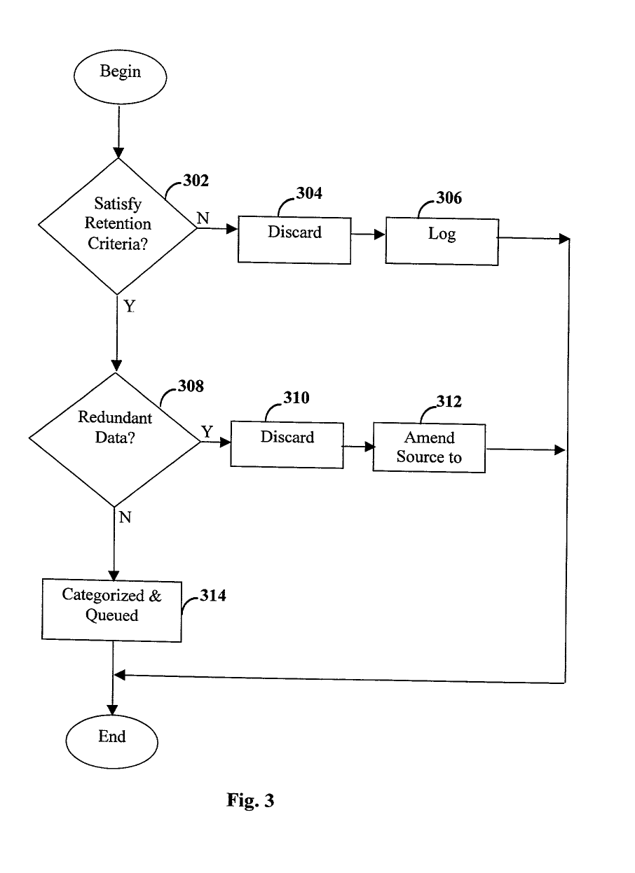

As data enters the system 200, it is preprocessed at step 106. Step 106 includes the initial filtering and categorization of intelligence data based on keyword searching, pattern matching, and content recognition functions. The data preprocessing step 106 is illustrated in further detail in FIG. 3.

A set of retention criteria that has been defined in the system by the system administrator filters the data at step 302. In one embodiment, the criteria includes the number of keyword hits on a source, a date/time stamp for recognizing the same data content and source already retained by the system, and a relevancy ranking on keyword hits to retain only the most relevant intelligence data reporting on the same issue. Intelligence data that does not satisfy the retention criteria at step 302 is discarded at step 304 from the system 200. The discard is logged at step 306 so that the system administrator can fine tune intelligence data searches as necessary. Intelligence data that satisfies the retention criteria is further assessed at step 308 to determine, recognize, and properly identify redundant items and conflicting items in the retained data. For example, two or more data sources may report on the same cyber-threat issue. Additionally, these sources may conflict in the disclosure of facts or opinion. Step 308 resolves these issues. Data items are checked against records already in the first level data store (discussed in detail below). If the data item is a redundancy, it is discarded at step 310 and the source of the redundant data is noted with the original record in the first level data store. Data items that are not redundant are categorized to one or more queues at step 314. Collectively, the queues comprise the first level data store.

In one embodiment, there are three categories which all data is classified into: sector, Area of Responsibility (AOR), and TIVC category. The sector category is comprised of, but not limited to, banking/finance, government, transportation, manufacturing, energy, information technology, and health. The AOR category is comprised of geographic regions. The TIVC category is comprised of Threats, Incidents, Vulnerabilities, and Countermeasures. Where intelligence data lies within these categories determines which queues it is routed to. The preprocessed data must remain in each queue until it is further processed by an analyst.

As data enters a queue, an analyst is made aware of its arrival by the system. The analyst reviews the new intelligence data in their specially assigned queue(s) at the data analysis step 108. At step 108, an analyst has access to a number of tools to facilitate the review of data in their respective queue(s). The tools provide the analysts with both ad-hoc and predefined query capabilities, including conceptual, pattern, and Boolean searching capabilities to review data in other queues and data in the second level data store. The method also requires analysts to use collaboration tools to automatically assist with information sharing, obtaining peer review, and reducing redundant entries or conflicting assessments. The tools support workflows for processing data according to the organizational hierarchy.

Once a source has been identified by the analyst to contain useful intelligence information, the analyst creates a record of the item at step 110. The analyst writes a paraphrased summary of the source, including the addition of a title and footnote information (source identification and date information). For each summary, the analysts then writes an “analysis” statement, which elaborates how the information contained in the summary could potentially affect the infrastructure or information security of a client subscribing to the cyber-threat alert service. At that time, the analyst makes a subjective “judgement call” regarding the significance of the analysis statement, and assigns a color code relative to the potential damage to the subscriber's systems and/or technology infrastructure. In one embodiment, red, yellow, and green equate to high, medium, and low, respectively. Finally, summary, analysis statement, and respective color code records are categorized into a TIVC category. Occasionally, a relevant piece of information is identified that does not fit any of these categories and is put into a “Advisory” category.

At step 110, the analyst will also enter meta-tag data for predetermined fields. This will facilitate with more accurate searching abilities once the data has been promoted to the second level data store. A senior level analyst will make the final determination of whether or not the analyst's entry is “promoted” to a second level data store. A record which is not promoted to the second level data store is removed from the analysts queue but remains as raw data in the first level data store as an entity in the database for research purposes. A record that is promoted to the second level data store will be referred to as a Knowledge Object (KO). KO's comprise the final form of the cyber-threat information that is delivered to clients subscribing to the service.

In order to create customized products for clients at step 112, client information is gathered from multiple sources at step 114. In one embodiment, these include surveys or on-line client request forms. This information is used to determine system dependencies about a client's particular network infrastructure. Factual data provided in the client information, along with the use of automated “filters”, makes it possible to create dynamic, customized intelligence and reporting. For example, individual responses from clients permit the creation of appropriate industry sector reports for a specific client group or client sector (e.g., Financial Services Sector). At step 112, the deliverable is formatted to meet the delivery requirements of each individual client and is delivered at step 116 in one or more of a plurality of formats and delivery methods.

Development of the system 200 for employing the method previously described will use commercial, off-the-shelf (COTS) software whenever possible. The selected hardware components must provide for easy expansion of storage and processing capability.

System 200 automates the capture and collection of data sources 201 for use in at he first level data store 210. Data sources 201 are captured and collected by the data collector module 202. The data collector module 202 is comprised of data collectors, and in one embodiment, include web spiders, web metacrawlers, email indexing objects, multimedia capture and indexing objects, optical character recognition (OCR) scanning and indexing objects, manual data entry objects, etc. A crawling interval for web sites is set by the system administrator (SA) 204 and is easily configurable through the SA interface 206, as well as the list of sites and sources that the data collectors search. The data collector module 202 has the capability to recognize when intelligence data from the data sources has been created, modified, or deleted and pulls new data into the system based on these earliest criteria.

Intelligence data received into the system 200 is passed from the collector module 202 to the data filter and preprocessor module 208. The data filter and preprocessor module 208 are a group of automated collection tools that perform initial filtering and categorization of intelligence data based on keyword searching, pattern matching, and content recognition functions before the data is passed on to a first level data store 210.

Because the data sources may be in a plurality of formats, the first level data store 210 uses a Relational Data Base Management System (RDBMS) that supports basic analytical functions including ranking, statistical aggregate functions, ratio calculations, period over period comparisons, etc. and has the ability to store data in various formats to facilitate both data collection and product production efforts. In one embodiment of the present invention, text, documents, audio/visual, graphics, and databases are only a few such types of files that are collected and stored by the system 200.

When new data enters the first level data store 210, the analyst 212 is made aware of its arrival by the Application & Workflow Server 214 through the Graphical User Interface (GUI) server 216. During the analysis, the system provides analysts 212 the ability to review data objects (as part of the first level data store queue 210) to determine whether an item will be “promoted” to the second level data store 220, also a RDBMS. During the analysis, the analyst 212 can use the query and peer collaboration tools that are driven by the Application & Workflow server 214. The peer collaboration tools support work flow processes to route items of interest back and forth between analysts 212 as they make notes (and internally query one another regarding the item). When queried, the system allows analysts to view returned data subsets in chronological and significance order according to the analysts' needs. The system 200 recognizes, enforces, and validates relationships between data elements. For all data types and fields, analysts 212 have the ability to retrieve and view all data stored in the first level data store 210 subject to the access control rules of the security boundary 218. Additionally, analysts 212 are not able to delete any document or data element from the first level data store 210 or second level data store 220. Only the SA 204 has these privileges. If an analyst 212 determines that the data object contains no useful intelligence data, the analyst 212 removes the item from one of that analyst's queues and the item is “returned” to the database (first-level data store 210). An audit record to track this action is created. However, the removal action does not cause that document or data element to be removed from any other analyst's queues. If an analyst determines that a data object contains relevant intelligence data, the data is promoted to a KO. Before the data object is promoted, tools driven by the Application & Workflow server 214 assist the analysts 212 in the tagging of the metadata types. In one embodiment, the list of tags include:

Relevant sector (or sectors)—Identified by analysts 212. One to many relationship meaning that a piece or source of data may contain information relevant to more than one sector.

Proprietary—Identified by analysts 212. Logical field indicating whether or not part or whole piece or source of data contains proprietary information. A system of checks and balances ill have to be identified that ensures that proprietary and/or sensitive information is not inappropriately disseminated.

Entity—Ability for analysts 212 to identify whether or not specific data pertains to a specific entity.

Data Time Group—This field will default to the current data time group, and will identify the data and time of record creation, change, or deletion.

Analyst ID—Defaults to the analyst 212 logged in on the system. Identifies who added, changed or deleted records.

Source Data—Identifies source data fields URLs, Serial Codes/Tracking, Report Order.

Validity—An indicator used to speculate how valid or invalid a document or information source is. For example, “High”, “Medium”, “Low”, with “Unknown” as possible values.

Country of Interest—A country may be of interest because it is the source of a problem, involved in the problem in some way, or the problem's effects may be noted there.

Group Involved—Specifies a given group involved in the particular problem, either as a cause, as a possible solution provider, or as a party involved in some other role. In one embodiment, the list of valid groups are comprised of terrorist, hacktivist, hacker, non-governmental organization, government, military.

Hardware Affected—Specifies a particular piece of hardware affected by the given problem. For example, a list of hardware may include entries such as Dell 440 PowerEdge Server, Cisco 12000 Series Gigabit Switch Router, 3Com Palm V PDA.

Operating System Affected—Specifies a particular operating system affected by the given problem. For example, operating systems listed may include Microsoft Windows 98, HP-UX 10.20, or Red Hat Linux 6.2.

Application Software Package Affected—Specifies a particular application software package affected by the given problem. For example, the list of possible packages may include Microsoft Outlook 2000, Oracle 81 Enterprise Edition for Windows NT, or Netscape Communicator.

These data tags permit enhanced searching capabilities of the data by analysts 212 and supervisors 222. In one embodiment, the system 200 supports the capability for searching a two-level meta-tagging data hierarchy for the fields Hardware Affected, Operating System Affected, and Application Software Package Affected. Once tagged by the system, a supervisor 222 reviews the KO and either promotes it to the second level data store 220 or returns it to the first level data store 210.

After data objects have been promoted to the second level data store 220, and have been cleared by a supervisor 222 for publication in the deliverable product, the second level data store 220 is replicated to a “published” KO database 224, also a RDBMS. The published KO database 224 is the source of information for both “push” products (products delivered to the client) and “pull” products (information clients can receive by searching the KO database 224). Therefore, the delivery system supports a distributed architecture with publishable data from the second level data store 220 being replicated to the delivery system. The replication 225 includes encryption during communication between the second level data store 220 and the published KO database 224 providing secure replication between the two data centers. Clients 226 do not directly access the data production system, but clients 226 may have access to this published database 224 using 128 and smaller encryption keys over HTTPS. The system 200 will customize the results page shown after a search according to criteria established by the client 226 and additional defined criteria that limits client access to published data. It is capable of both predefined and ad-hoc searches on the published KO database 224. Clients 226 do not have the ability to add, change, or delete data in the system 200 or view the raw or first level data items in the first level data store 210.

In one embodiment, the system 200 is capable of web delivery using HTTPS via the web server 228. The web delivery system does not require the client's browser to support Cookies, JavaScript, or Java for state management and user identification and should be available 24 hours a day and seven days a week. Content is retrieved by the application server 230 from the published database 224 and delivered over the Internet by the web server 228. The web delivery user interface is well organized and easy to navigate and provides clients with the ability to customize and personalize many of the dynamic content pages. The application server 230 has the ability to match client profile information against the published database 224 to produce and deliver customized, personalized intelligence data for clients 226. The site delivers a dynamic stream of information and analysis on threats, vulnerabilities, incidents, and countermeasures as they relate to a client's 226 enterprise.

In an alternative embodiment, email delivery of the product is possible by an email server 228. The email system supports a customized, dynamic report delivery as they relate to the client's 226 enterprise. The report is sent at the time specified in the client's profile, and the system allows analysts to invoke sending an immediate report. The email reports are automatically created using the client's 226 profile by the application server 230 to select the appropriate entries from the published database 224. Entries for email delivery is sorted and formatted in a similar layout to the web delivered reports, however the physical format of the report is selected by the client 226, and the system can accommodate multiple formats such as Portable Document Format (PDF), Hyper Text Markup Language (HTML), and/or ASCII text. The emails are encrypted according to the client's 226 preference for PGP, RSA or other methods and should contain a digital signature.

In another alternative embodiment, product delivery takes the form of a facsimile. The system 200 includes a facsimile server 228 capable of delivering 200 facsimile pages per day. Clients 226 can receive facsimile copies if this is noted in their client profile. The fax is sent at the time specified in the client's profile, and the system 200 allows analysts to invoke sending an immediate report. Again, the reports are created using the client's profile to select the appropriate entries from the published database 224. The entries are sorted and formatted in a similar layout to the web delivered reports. The client 226 select the desired format for the faxed reports.

The system 200 also supports the collection of client profile information 232. In one embodiment, a client's profile is collected via HTTPS over the Internet and processed by the application server 230. The client care management 234 supports administrative functions such as adding clients, deleting clients, modifying clients information, updating client profiles, updating client sector information for the filters, and sending immediate reports.

In an alternative embodiment, clients 226 can send client information via a plurality of sources including surveys, mail notes, document attachments, etc. Client care management 234 can then directly access the client profile information site 32 to input the data into the system 200.

While this invention has been described in conjunction with specific embodiments thereof, it is evident that many alternatives, modifications and variations will be apparent to those skilled in the art. Accordingly, the preferred embodiments of the invention as set forth herein, are intended to be illustrative, not limiting. Various changes may be made without departing from the true spirit and full scope of the invention as set forth herein and defined in the claims.

What is claimed is:

1. A method for monitoring cyber-threats for subscribers of a cyber-threat alert service comprising:
collecting intelligence data,
storing said data in a first data store,
analyzing the data to determine if said intelligence data is to be retained,
discarding data not to be retained while retaining data that satisfies a predetermined criteria, and
distributing the retained data to selected subscribers.

2. A method as set forth in claim 1 further comprising creating a record in a second data store when intelligence data is retained.

3. A method as set forth in claim 2 further including replicating the record in the second data store to a published database for making the intelligence data available to the subscribers.

4. A method as set forth in claim 1 further including maintaining profiles of the subscribers of record in the data base such that data relevant to the profiles of the subscribers may be “pushed” or “pulled”.

5. The method as set forth in claim 4 wherein the collection of data includes initial filtering and categorization of the data based on keyword searching, pattern matching and content recognition.

6. The method as set forth in claim 4 wherein retained data is further assessed to determine, recognize and identify redundant and conflicting items in the retained data.

7. The method as set forth in claim 6 further comprising categorizing data that is not redundant into one or more queues.

8. The method as set forth in claim 2 further including coding said record created according to the potential for the data to affect the infrastructure or information security of the subscribers.

9. A system for monitoring cyber-threats for subscribers of a cyber-threat alert service, comprising:
a data collector 202 for capturing and collecting intelligence data from
a plurality of data sources 201,
a data filter and preprocessor connected to the data collector for filtering and categorizing the collected intelligence data,
a first level data store for receiving filtered and categorized data,
a second level data store,
means for promoting to the first level data to the second level data store,
means for tagging data to be promoted, and
means for distributing tagged data to subscribers.

10. The system of claim 9, wherein the first level data store is a relational database management system.

11. The system of claim 9, wherein the second level data store is a relational database management system.

12. The system of claim 9, wherein the first level data store and the second level data store are relational database management systems.
